(19) United States
(12) Patent Application Publication
(10) Pub. No.: US 2016/0259982 A1
(43) Pub. Date: Sep. 8, 2016

(54) VEHICLE VIEW MONITORING SYSTEM

(71) Applicants: Mrs. Kavitha Kodinagenahalli Shivanandaiah, Wildwood, MO (US); Mrs. Suhasini Balachandran, Wildwood, MO (US)

(72) Inventors: Kavitha Kodinagenahalli Shivanandaiah, Wildwood, MO (US); Suhasini Balachandran, Wildwood, MO (US)

(21) Appl. No.: 14/948,329

(22) Filed: Nov. 22, 2015

(30) Foreign Application Priority Data
Mar. 7, 2015 (IN) 1124/CHE/2015

(51) Int. Cl. G06K 9/00; H04B 7/26; B60R 11/04; H04N 7/18

(52) U.S. Cl. CPC G06K 9/00791; H04N 7/183; H04B 7/26; B60R 11/04

(57) ABSTRACT

A method and apparatus for coupling a vehicle view monitoring system between a vehicle and a cell phone are disclosed. Coupling a camera to a vehicle, connecting a controller to the camera, and connecting a cellular phone to the controller, the controller activates the camera to facilitate displaying one of a front portion and a rear portion of the vehicle on a display panel of the cellular phone are also disclosed.

### FIELD OF THE INVENTION

This invention relates generally to a camera and more specifically to connecting the camera that is present in a vehicle to a cellular phone via a control unit.

### BACKGROUND OF THE INVENTION

Consumers who use vehicles employ a reverse parking camera and assist system to determine a rear view of the vehicle. The reverse parking camera and assist system determines if the rear view of the vehicle is clear, or if there are obstructions present in the line of sight of the vehicle. This information is relayed to a driver of the vehicle. However, due to a high expense associated with purchasing and maintaining the reverse parking camera and assist system, a low cost alternative is required. The need has existed for many years, yet there is no fully satisfactory system to meet the need. In accordance with a long recognized need, there has been developed a camera that is connected to a cellular phone via a control unit. A software application in the cellular phone displays the rear view of the vehicle to enable effective navigation by the driver. The camera itself is compact and easily interchangeable with cellular phones of various types. It is a versatile device in that it can be used to display the rear view of the vehicle on a display panel of the cellular phone as the need dictates. Importantly, the camera in the vehicle connected to the cellular phone is efficient in operation.

CN Patent Number 202753909 U describes a vehicle mounted monitoring system, and particularly to a vehicle mounted rear view mirror monitoring system. The vehicle mounted rear view mirror monitoring system comprises a backstage server, a cell phone, a vehicle mounted intelligent terminal, a front camera, a rear camera and a microphone device. The vehicle mounted intelligent terminal, the front camera, the rear camera and the microphone device are arranged in a rear view mirror shell body. According to the vehicle mounted rear view mirror monitoring system, the backstage server transmits relative protocols to the vehicle mounted intelligent terminal through the internet and achieves functions of photographing, video recording, monitoring and remote monitoring through the cameras and microphones arranged in a rear view mirror. In addition, a user can monitor conversations of people in a vehicle by calling an anti-theft number through the cell phone by sending a short message. A global position system (GPS) is connected with the vehicle-mounted rear view mirror monitoring system. A vehicle owner transmits an instruction of position query to the vehicle mounted intelligent terminal by sending a short message. Position information can be transmitted back to the cell phone of the user.

### BRIEF DESCRIPTION OF THE INVENTION

In one aspect, a vehicle view monitoring system 10 is described. The vehicle view monitoring system 10 comprises a camera 12 coupled to a vehicle. A control unit 14 is connected to the camera 12. A cellular phone 16 is connected to the control unit 14, wherein the control unit 14 activates the camera 12 to facilitate displaying one of a front portion and a rear portion of the vehicle on a display panel of the cellular phone 16.

In another aspect of the invention, a control unit 14 for a vehicle view monitoring system 10 is described. The control unit 14 is adapted to receive a first electronic signal from a camera 12 that is coupled to a vehicle. The control unit 14 transmits a second electronic signal to a cellular phone 16, wherein the second electronic signal is indicative of a view of one of a front portion and a rear portion of the vehicle.

### BRIEF DESCRIPTION OF THE DRAWING

FIG. 1 is a block diagram of a control unit in electrical communication with a cellular phone and a camera.

### DETAILED DESCRIPTION OF THE INVENTION

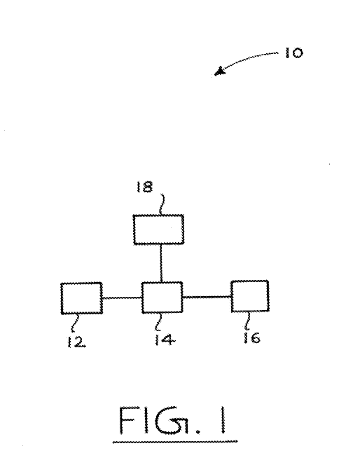

FIG. 1 is a block diagram of a vehicle view monitoring system 10. More specifically, in the exemplary embodiment, a control unit 14 is in electronic communication with a camera 12 and is configured to transmit an electronic signal to a cellular phone 16.

The camera 12 is any type of camera that enables functioning of the control unit 14 therein. The camera 12 is one of a digital video camera/digital photo frame camera to capture video recordings/photographic images. The camera 12 is coupled to one of a front portion and a rear portion of a vehicle. More specifically, the camera 12 captures a video recording/photographic image of a view of one of the front portion and the rear portion of the vehicle.

An electronic signal containing the video recording/photographic image is transmitted from the camera 12 to the control unit 14. The electronic signal transmitted from the camera 12 to the control unit 14 is a first electronic signal. In an embodiment, the camera 12 may be connected to the control unit 14 via wiring means. Alternatively, the camera 12 may be connected to the control unit 14 via a USB/Bluetooth/infrared transmission means or any other wireless transmission means known in the art. The control unit 14 may process the signal received from the camera 12 and transmit a corresponding electronic signal that may be capable of being received and displayed on a display panel of a cellular phone 16. The electronic signal transmitted from the control unit 14 to the cellular phone 16 is a second electronic signal. The second electronic signal may have the same characteristics of the first electronic signal. The cellular phone 16 may be connected to the control unit 14 via a network. In an embodiment, the network may be a wired/wireless network. Alternatively, the electronic signal received from the control unit 14 by the cellular phone 16 may be processed within the cellular phone 16 itself. The video recording/photographic image is displayed on the display panel of the cellular phone 16 to intimate the user of the video recording/photographic image that is captured by the camera 12. In an embodiment, the cellular phone 16 may access the video recording/photographic image from the control unit 14 via an application that is stored in the cellular phone 16.

A gear sensor 18 is connected to the control unit 14. Specifically, the gear sensor 18 transmits an electronic signal to the control unit 14 when a gear of the vehicle has been engaged in reverse gear. Alternatively, the gear sensor 18 transmits an electronic signal to the control unit 14 when the gear of the vehicle has been engaged in forward gear. When the gear of the vehicle has been engaged in forward gear, the control unit 14 activates the camera 12 to capture a video recording/photographic image of the view in a forward portion of the vehicle. When the gear of the vehicle has been engaged in reverse gear, the control unit 14 activates the camera 12 to capture a video recording/photographic image of the view in a rear portion of the vehicle. An electronic signal from the camera 12 containing the video recording/photographic image of the view in the forward portion of the vehicle and the rear portion of the vehicle is transmitted to the control unit 14 when the gear of the vehicle has been engaged in one of the forward gear and reverse gear respectively.

In an alternate embodiment, the control unit 14 includes a switch. The switch may be activated by a user to activate the camera 12 to capture the video recording/photographic image of the view in the forward portion of the vehicle. In addition, the switch may be activated by the user to activate the camera 12 to capture the video recording/photographic image of the view in the rear portion of the vehicle. The switch may be located either on the control unit 14 or on a dash board of the vehicle for easy accessibility by the user.

In an embodiment, two independent cameras may be coupled to the front portion of the vehicle and the rear portion of the vehicle to capture the video recording/photographic image of the view in the forward portion of the vehicle and the rear portion of the vehicle respectively. In an alternate embodiment, a single camera may be adapted to be swiveled about a vertical axis to capture the video recording/photographic images of a 360 degree view around the vehicle. The captured video recording/photographic images of the 360 degree view around the vehicle may be displayed on the display panel of the cellular phone 16. In an embodiment, the camera 12 may be mounted on a front bumper, a rear bumper, and on a top portion of the vehicle. Alternatively, the camera 12 may be mounted anywhere about the vehicle that enables effective functioning of the vehicle view monitoring system 10 thereto.

An operation of the vehicle view monitoring system 10 is described as an example. When a gear of the vehicle has been engaged in one of the reverse gear and the forward gear, the gear sensor 18 transmits an electronic signal to the control unit 14 indicating that the gear of the vehicle has been engaged in one of the reverse gear and the forward gear respectively. Alternatively, the control unit 14 receives an electronic signal that the vehicle has been engaged in reverse gear or forward gear via a communication bus such as but not limited to CAN, Flexray and the like. Therein the control unit 14 activates the camera 12 to capture one of the video recording/photographic image of the view in one of the forward portion and the rear portion of the vehicle. The video recording/photographic image captured by the camera 12 is therein transmitted to the cellular phone 16 and displayed on the display panel of the cellular phone 16 via the control unit 14. Therefore, the user can view the video recording/photographic image on the display panel of the cellular phone 16 in a cost effective manner via an application installed on the cellular phone 16. The application required to view the video recording/photographic image may be downloaded by the cellular phone 16 from the internet. In yet another alternate embodiment, the control unit 14 may receive an electronic signal transmitted from the cellular phone 16 by the user in order to activate the camera 12. The electronic signal received by the control unit 14 from the cellular phone 16 is a third electronic signal. The activated camera 12 therein transmits an electronic signal containing the video recording/photographic image of the forward portion of the vehicle and the rear portion of the vehicle to the control unit 14.

The above described control unit 14 in electrical communication with the cellular phone 16 and the camera 12 is cost effective and highly reliable. The control unit 14 in electrical communication with the cellular phone 16 and the camera 12 facilitates viewing one of the front portion and the rear portion of the vehicle.

Exemplary embodiments of a vehicle view monitoring system 10 are described above in detail. The systems are not limited to the specific embodiments described herein, but rather components of each system may be utilized separately and independently from other components described herein.

While the invention has been described in terms of various specific embodiments, those skilled in the art will recognize that the invention can be practiced with modifications within the spirit and scope of the claims.

What is claimed is:

1. A vehicle view monitoring system, said vehicle view monitoring system comprising:
a camera coupled to a vehicle;
a controller connected to said camera; and
a cellular phone connected to said controller, said controller activates said camera to facilitate displaying one of a front portion and a rear portion of said vehicle on a display panel of said cellular phone.

2. The vehicle view monitoring system in accordance with claim 1 further comprising a gear transducer connected to said controller.

3. The vehicle view monitoring system in accordance with claim 2 wherein said controller activates said camera when said gear transducer transmits an electronic signal to said controller indicating that a gear of said vehicle is engaged.

4. The vehicle view monitoring system in accordance with claim 3 wherein said gear of said vehicle may be engaged in one of a forward gear and a reverse gear.

5. The vehicle view monitoring system in accordance with claim 1 wherein said controller activates said camera when an electronic signal may be received from said cellular phone.

6. The vehicle view monitoring system in accordance with claim 1 wherein said camera may be adapted to be swiveled about a vertical axis to facilitate displaying a 360 degree view around said vehicle on said display panel of said cellular phone.

7. A controller for a vehicle view monitoring system, said controller adapted to:
receive a first electronic signal from a camera that may be coupled to a vehicle in an electronic receiver that may be coupled to said controller; and
transmit a second electronic signal from an electronic transmitter that may be coupled to said controller to a cellular phone that may be in electronic communication with said controller, said second electronic signal indicative of a view of one of a front portion and a rear portion of said vehicle.

8. The controller in accordance with claim 7 wherein said controller is in electronic communication with a gear sensor, said controller receives the first electronic signal from said camera when a gear of said vehicle is engaged.

9. The controller in accordance with claim 8 wherein said gear of said vehicle is engaged in one of a forward gear and a reverse gear.

10. The controller in accordance with claim 7 wherein said controller receives the first electronic signal from said camera when a third electronic signal may be received from said cellular phone.
